(19) United States
(12) Patent Application Publication
(10) Pub. No.: US 2010/0126023 A1
(43) Pub. Date: May 27, 2010

(54) Combination String Trimmer and Blower Tool

(75) Inventors: Neil G Griffin, Chandler, AZ (US); Raul Vidal, Phoenix, AZ (US); Barney Sing, Chandler, AZ (US); Kerry Roosmalen, Madison, MS (US)

Correspondence Address: WEGMAN, HESSLER & VANDERBURG, 6055 ROCKSIDE WOODS BOULEVARD, SUITE 200, CLEVELAND, OH, 44131, US

(73) Assignee: MTD Products Inc., Valley City, OH (US)

(21) Appl. No.: 11/988,249

(22) PCT Filed: Sep. 16, 2005
(86) PCT No.: PCT/US2005/033458

§ 371 Date: Jan. 15, 2009

Related U.S. Application Data
(60) Provisional application No. 60/696,738, filed on Jul. 6, 2005.

(51) Int. Cl. A01D 42/06; A01D 34/62

(52) U.S. Cl. 30/123; 30/276

(57) ABSTRACT

A multi-purpose tool (10) is used as an air blower capable of delivering a high-velocity stream of air when in a blower mode of operation and as a rotating string trimmer capable of trimming vegetation when in a trimmer mode of operation. The tool has a blower housing (18) including an enclosed chamber (30), a plurality of vents (35) leading to the chamber, and a blower nozzle (32) for directing air from the chamber, wherein the impeller (20) is rotatably mounted in the chamber such that the housing defines an air pathway between the vents and the impeller. The multi-purpose tool also includes means (82) for blocking the flow of air between vents and the impeller when in the trimmer mode of operation and means (99, 124) for disengaging the trimmer head (22) from the internal drive shaft (26) when in the blower mode.

### CROSS REFERENCE TO RELATED APPLICATION

The present application claims priority under 35 U.S.C. §119(e) to U.S. Provisional Patent Application No. 60/696,738, filed Jul. 6, 2005.

### BACKGROUND OF THE INVENTION

1. Field of Invention

This invention relates to hand-held lawn and garden tools and more specifically to a combination hand held string trimmer/blower device for use in cutting vegetation and clearing sidewalks, driveways, and the like free from debris.

2. Description of Related Art

It is known in the art to provide a string trimmer with one or more cutting strings or cutting blades to be used to cut vegetation such as grass and the like. It is also known in the art to use a separate blower device to clear debris from sidewalks, driveways, and the like. There have been several attempts to combine a string trimmer with a blower by attaching a separate blower impeller to the string trimmer.

Typically, in order to attach the impeller, the operator would have to remove a fastening device, and then remove the string trimmer head before attaching the blower impeller. This is a very tedious and time-consuming manner in which to convert a string trimmer to a blower. In addition, due to the configuration of the blower attachment, it is likely that the blower attachment will only fit on a limited number of line trimmers.

The present invention provides methods and apparatuses for a new and improved combination blower/string trimmer device, which is simple in design, effective in use, and overcomes the aforementioned disadvantages.

### SUMMARY OF THE INVENTION

One aspect of the invention is directed to a portable multi-purpose tool. The power tool is powered by an attached power source for use as an air blower capable of delivering a high-velocity stream of air when the multi-purpose tool is in a blower mode of operation and as a rotating string trimmer capable of trimming vegetation when the multi-purpose tool is in a trimmer mode of operation. The multi-purpose tool includes a shaft boom and a drive shaft operatively connected to the power source and configured to be rotated by the power source. The multi-purpose tool also includes an impeller operatively connected to the drive shaft so as to be rotatable by the power source and a trimmer head positioned below the impeller, the trimmer head operatively connected to the drive shaft so as to be selectively rotatable by the power source. The multi-purpose tool also includes a blower housing at a distal end of the shaft boom, the blower housing defining an enclosed chamber and has a plurality of vents leading to the chamber and a blower nozzle for directing air from the chamber, wherein the impeller is rotatably mounted within the chamber, and the housing defines an air pathway between the vents and the impeller. The blower housing is mounted such that the housing is movable between a first and a second position relative the distal end of the shaft boom such that when the multi-purpose tool is in the blower mode of operation, the housing is in the first position and the pathway is open so that air flows through the vents and to the impeller, and when the multi-purpose tool is in the trimmer mode of operation, the housing is in the second position and the pathway is substantially blocked by an air blocking mechanism so that air is substantially prevented from flowing between the vents and the impeller. The multi-purpose tool also includes an actuator that moves the housing between the first position and the second position relative to the distal end of the shaft boom.

Another aspect of the invention is directed to portable multi-purpose tool powered by an attached power source for use as an air blower capable of delivering a high-velocity stream of air when the multi-purpose tool is in a blower mode of operation and as a rotating string trimmer capable of trimming vegetation when in a trimmer mode of operation. The multi-purpose tool includes a tubular shaft boom and an internal drive shaft operatively connected to the power source and configured to be rotated by the power source. The multi-purpose tool also includes an impeller operatively connected to the internal drive shaft so as to be rotatable within the chamber and a trimmer head positioned below the impeller, the trimmer head operatively connected to the internal drive shaft so as to be selectively rotatable by the power source. The multi-purpose tool also includes a blower housing at a distal end of the shaft boom having an enclosed chamber, a plurality of vents leading to the chamber, and a blower nozzle for directing air from the chamber, wherein the impeller is rotatably mounted in the chamber such that the housing defines an air pathway between the vents and the impeller, wherein the blower housing is mounted such that the housing is movable between a first and a second position relative the distal end of the shaft boom. The multi-purpose tool has an actuator that moves the housing relative the distal end of the shaft boom between a first position for the blower mode of operation and a second position for the trimmer mode of operation. The multi-purpose tool also has a clutching mechanism configured to selectively clutch the trimmer head when in the trimmer mode of operation and declutch the trimmer head when in the blower mode of operation. The clutching mechanism includes a centrifugal clutch affixed to the internal drive shaft and a clutch drum affixed to the trimmer head, wherein the clutch drum is movable with the blower housing between first and second positions such that the centrifugal clutch nests within and engages the clutch drum when the housing is positioned in the trimmer mode of operation and the centrifugal clutch is positioned outside the clutch drum when the housing is positioned in the blower mode of operation so that the centrifugal clutch does not engage the clutch drum.

### BRIEF DESCRIPTION OF THE DRAWINGS

The above mentioned and other features of this invention will become more apparent and the invention itself will be better understood by reference to the following description of embodiments of the invention taken in conjunction with the accompanying drawings, wherein:

FIG. 1 is a perspective view of the upper side of a trimmer/blower tool;

FIG. 2 is a side perspective view of the trimmer/blower tool of FIG. 1;

FIG. 3 is an exploded perspective view of the trimmer/blower tool of FIG. 1 with portions of the housing removed for clarity;

FIG. 4 is an exploded perspective view of the housing illustrating the chamber formed therein;

FIG. 5 is a side view showing the trimmer/blower tool in the trimmer mode;

FIG. 6 is a side view showing the trimmer/blower tool in the blower mode;

FIG. 7 is an exploded perspective view of a second embodiment of the trimmer/blower tool; and

FIG. 8 is an exploded perspective view of a third embodiment of the trimmer/blower tool.

Corresponding reference characters indicate corresponding parts throughout the views of the drawings.

### DETAILED DESCRIPTION OF EXEMPLARY EMBODIMENTS

The invention will now be described in the following detailed description with reference to the drawings, wherein preferred embodiments are described in detail to enable practice of the invention. Although the invention is described with reference to these specific preferred embodiments, it will be understood that the invention is not limited to these preferred embodiments. But to the contrary, the invention includes numerous alternatives, modifications and equivalents as will become apparent from consideration of the following detailed description.

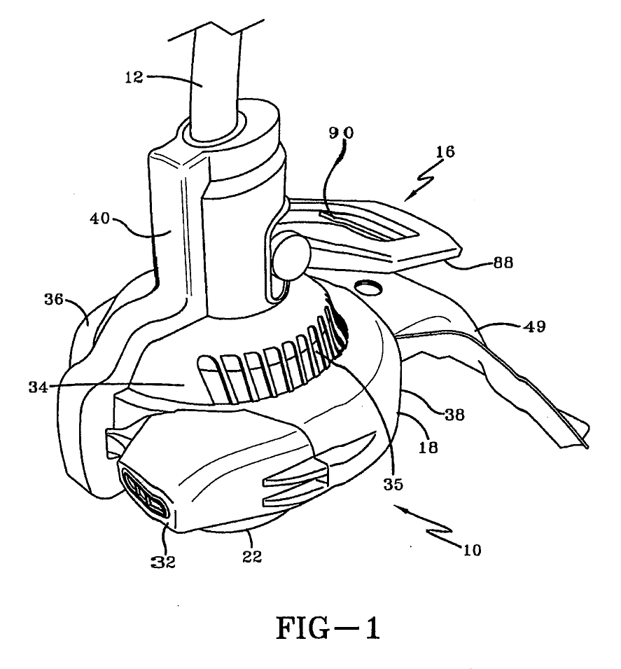

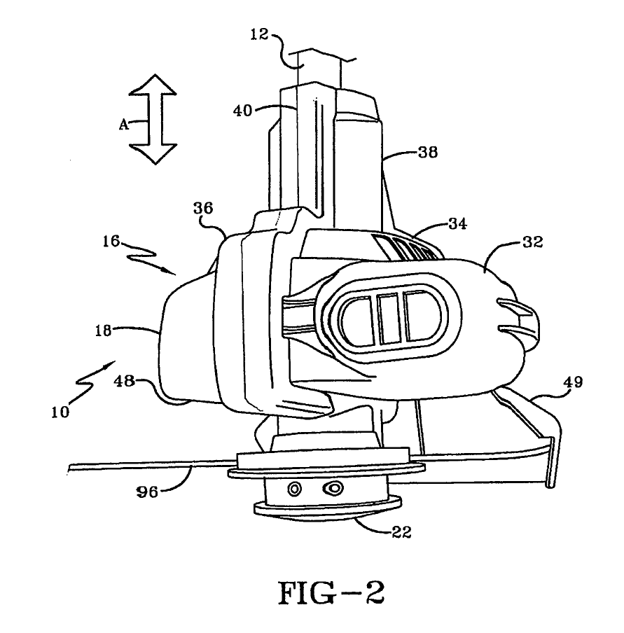

Referring now to the drawings, FIGS. 1 and 2 show a portable, hand-held multi-purpose power tool 10 according to one embodiment of the invention that functions as both a string trimmer and an air blower. The power tool 10 is provided with an elongated protective tubular shaft boom 12 with a power source (not shown) positioned at one end of the shaft boom 12 and at least one handle (not shown) for manipulation of the tool 10. The power source of the tool 10 can be either a gasoline engine or an electric motor, both of which are well known in the art and need not be discussed in further detail. According to the invention, the tool 10 has a blower/trimmer assembly 16 connected to a working end of the shaft boom 12 that is driven by the power source. The blower/trimmer assembly 16 permits the tool 10 to be used either as a hand-held blower capable of delivering a high-velocity stream of air from a blower housing or volute 18 useful for blowing debris off walkways and the like, or as a rotatable string trimmer useful for trimming and cutting vegetation. Desirably, the operator of the tool 10 can quickly and easily manipulate the blower/trimmer assembly 16 to select the desired mode of operation without the need of extra tools or without having to add or remove additional components.

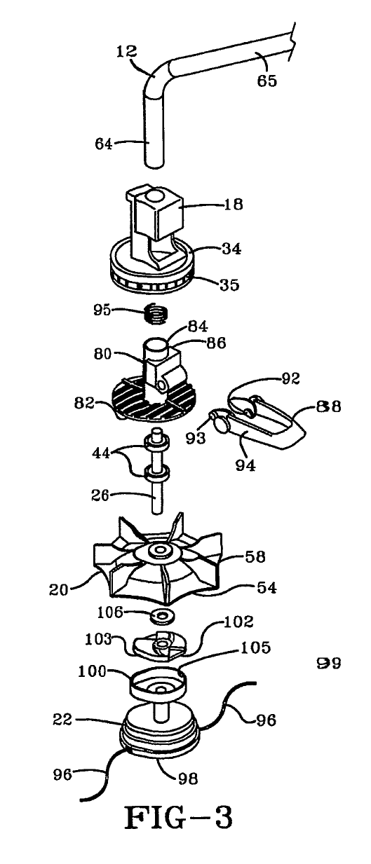

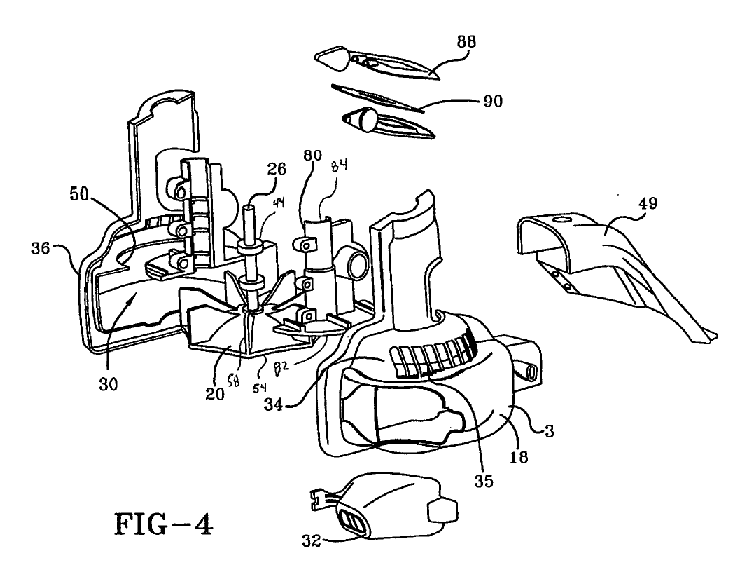

Turning now to FIGS. 3 and 4, the blower housing 18 (only part of which is illustrated in FIG. 3 for clarity) contains a rotatable impeller 20 configured to impart energy to the high-velocity stream of air while in the blower mode of operation. Below the housing 18, the blower/trimmer assembly 16 also has a rotatable string trimmer head 22 used for cutting vegetation. The protective tubular shaft boom 12 houses a rotatable flexible drive shaft (not shown) that extends throughout the shaft boom 12 and operatively connects the power source to an internal drive shaft 26 located within the housing 18. Flexible drive shafts in and of themselves are known in the art and need not be described in detail. However, means for connecting the flexible drive shaft to selectively engage the impeller 20 and/or the trimmer head 22 so as to provide both blowing and cutting capabilities from the same tool 10 will be described below. The internal drive shaft 26 operatively connects the power source to the impeller 20 and to the string trimmer head 22 to provide the necessary rotating motion as will be set forth more fully below.

As best seen in FIG. 4, the blower housing 18 forms an enclosed chamber 30 in which the impeller 20 is located. The chamber 30 leads to an outlet nozzle 32 for directing the high velocity stream of air created by the impeller 20. The outlet nozzle 32 comprises an air outlet for directing air pressurized in the chamber 30 out of the blower housing 18 and is generally tangentially aligned with the outer periphery of impeller 20. In one embodiment, the nozzle 32 is generally cone shaped and can be threaded onto the blower housing 18 or attached with fasteners to form the air outlet. In operation, air is drawn into the chamber 30 by the impeller 20 and expelled at a relatively higher velocity through the nozzle 32. The housing 18 has a shroud portion 34 that contains a plurality of vents or windows 35 therein. The vents 35 are designed to permit air to enter the enclosed chamber 30 and reach the impeller 20 when in the blower mode of operation. By an enclosed chamber 30 it is meant that the chamber substantially surrounds the impeller 20 so that the impeller is able to pressurize the air drawn in through the vents 35 and expel the air out of the chamber through the nozzle 32.

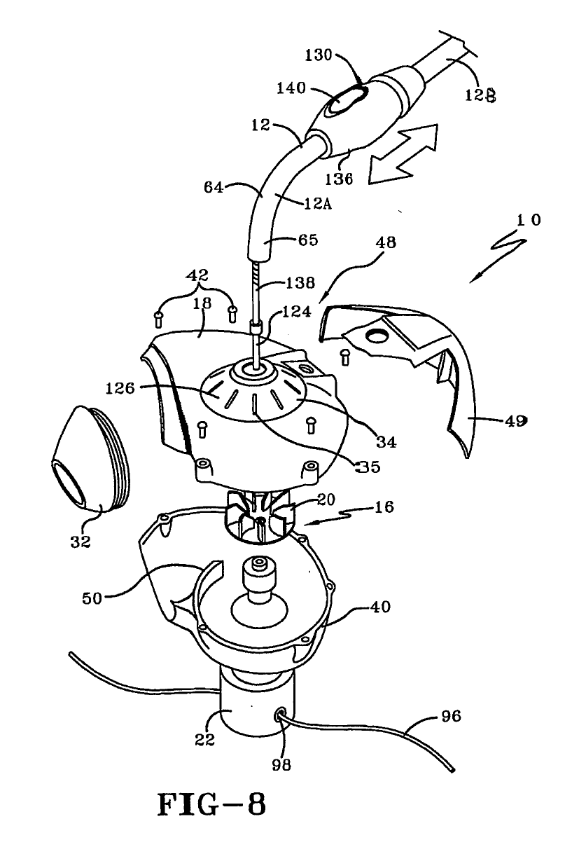

The blower housing 18 is desirably fabricated as a two-piece housing 18 formed with mating housing shells 36 and 38. The blower housing 18 may be made from a suitable polypropylene, polyvinyl chloride (PVC) or other plastic material or the like and is desirably formed by plastic injection molding. Desirably, the blower housing 18 comprises right and left housing shells 36, 38 joined together at a flange connection 40 with screws, rivets or other suitable fasteners 42 (seen in FIG. 7). Alternately, the blower housing 18 has a generally concave upper housing shell 36 (i.e., as shown in the embodiment depicted in FIG. 8) and a generally concave lower housing shell 38. Thus, it is to be understood that the invention is not limited to any particular shape or method of fabrication of the blower housing 18. As such, the terms “right” and “left” and “upper” and “lower”, as used in describing the housing shells, and any other portion of the tool 10, are used to aid in describing the housing shells and should not be interpreted as limiting. Other dome or dish geometric shapes for the housing shells can also be used without departing from the scope of the invention.

Bearings or bushings 44 permit rotation of the internal drive shaft 26 with respect to the blower housing 18. The bearings 44 can be sleeve bearings or other conventional bearings chosen with sound engineering judgment.

The housing 18 further acts as a debris shield to protect the operator from flying vegetation clippings cut by the trimmer head 22 when the tool 10 is operating in the trimmer mode of operation. As best seen in FIG. 1, the debris shield desirably includes the blower housing 18 and an extension guard 49 that extends from the blower housing 18. The extension guard 49 may be manufactured as a single integrated part of the housing 18 or the extension guard 49 may consist of one or more separate pieces attached to the housing 18. In such case, the extension guard 49 can be attached to the blower housing 18 by any mechanical means necessary chosen with sound engineering judgment. Preferably, the extension guard 49 is positioned on the housing 18 on the side opposite blower nozzle 32.

As best seen in FIG. 4 and in the alternate embodiments depicted in FIGS. 7 and 8, a spiral partition 50 is formed within the blower housing 18, so that when the housing shells 36 and 38 are joined, the spiral partition 50 forms the volute shaped chamber 30 having a center coaxial with the impeller 20 and a radius which varies circumferentially around the blower housing 18. By volute shape, it is meant that the chamber 30 forms a curved funnel generally increasing in area to the air outlet nozzle 32. In the embodiment illustrated in FIG. 8, the spiral partition 50 comprises a wall half formed in the lower shell 38 and half formed in the upper shell 36 so that when joined, the partition 50 extends between upper and lower portions of the housing 18. However, it is to be understood that the spiral partition 50 may be formed by other means using sound engineering judgment.

The impeller 20 resides within the chamber 30 formed by the housing shells 36, 38. The impeller 20 consists of a substantially circular shaped plate 54 mountable on the internal drive shaft 26 so as to be rotatable within the chamber 30. In one embodiment, the impeller 20 desirably comprises a plurality of airfoils 58 that have an arc-like shape. In the illustrated embodiment, the impeller 20 consists of seven airfoils 58. However, the impeller 20 may consist of any number of airfoils 58 chosen with sound engineering judgment. The airfoils 58 can be connected to the plate 54 by any mechanical means necessary chosen with sound engineering judgment. When rotated in the blower mode of operation, the impeller 20 is capable of delivering a high-velocity stream of air out of the nozzle 32. In one embodiment, the tubular shaft boom 12 of the multi-purpose power tool 10 has a bend 64 near its distal end 65 so that a central axis thereof extends generally coaxially through the blower housing 18 and is preferably aligned with the axis of rotation of the impeller 20.

The internal drive shaft 26 engages the impeller 20 and the string trimmer head 22 by any mechanical means chosen with sound engineering judgment. In the illustrated embodiment, the internal drive shaft 26 has an engaging shape and is received within a receiving aperture in the impeller 20 having a corresponding female shape to enable the torque of the internal drive shaft 26 to be passed on to the impeller 20. The shape of the internal drive shaft 26 may be any shape suitable such as square, star, triangular, octagonal and the like.

In one embodiment, a support collar 80 is positioned within the housing 18 above the impeller 20. The support collar 80 includes a lower restrictor plate 82 and an upper hollow tube section 84 with a ring clamp 86 that affixes the support collar 80 to the distal end 65 of the shaft boom 12. A handle assembly 88, broadly an actuator, attaches to the support collar 80. The handle assembly 88 is used to selectively adjust the position of the housing 18 between a first and a second position relative the boom 12 and support collar 80 as indicated by the arrow A in FIG. 2 in order to shift the tool 10 between a blower mode of operation and a trimmer mode of operation. As best seen in FIG. 3, the handle assembly 88 desirably has a catch 90 that must be pulled back before the handle assembly 88 can be repositioned. The catch 90 discourages inadvertent movement of the handle assembly 88 which could cause undesired engagement of the trimmer head 22 or air discharge from the blower nozzle 32. The catch 90 locks into a groove (not shown) on the support collar 80. The handle assembly 88 is pivotably attached to the support collar 80 with a pair of inwardly facing bosses 92 on arms 94 of the handle assembly 88. The handle assembly 88 is further attached to the housing 18 with guides 93 that move the housing 18 up or down when the handle assembly 88 is pivoted about the bosses 92. In one embodiment, a biasing spring 95 biases the housing 18 into the trimmer mode position. However, one will understand that the spring 95 may bias the housing 18 into the blower mode position without departing from the scope of the invention.

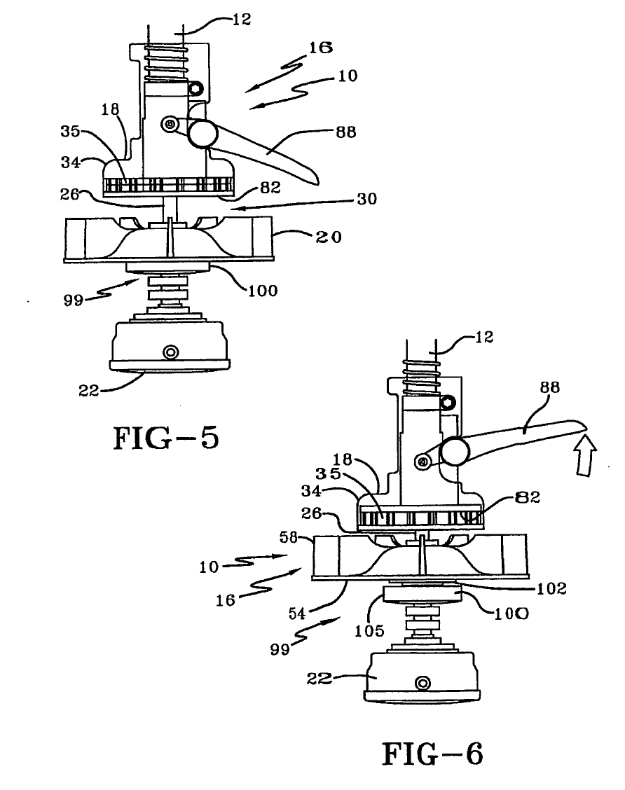

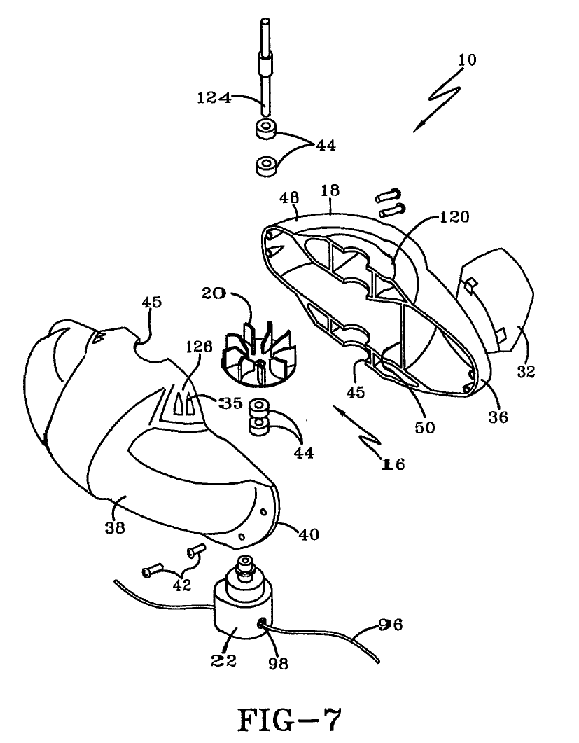

With reference now to FIGS. 5 and 6, the restrictor plate 82 fits within the shroud portion 34 of the housing 18 and has an outside diameter that is generally the same as the interior diameter of the shroud portion 34. When the housing 18 is selectively positioned into the trimmer position as illustrated in FIG. 5 by positioning the handle assembly 88, the housing 18 is moved upward relative to the restrictor plate 82 such that the vents 35 become positioned above the restrictor plate 82. In this orientation, the restrictor plate 82 forms an air blocking mechanism that blocks a substantial amount of the airflow between the vents 35 and the volute chamber 30. Although the impeller 20 continues to rotate within the volute chamber 30, the blower function of the tool 10 is essentially disabled as only a limited amount of air, if any, exits the blower nozzle 32. Alternately, when the handle assembly 88 is selectively positioned into the blower mode position as shown in the embodiment depicted in FIG. 6 by positioning the handle assembly 88, the housing 18 moves downward relative the shaft boom 12 and support collar 80 such that the vents 35 are positioned below the restrictor plate 82. In this orientation, air is free to enter the vents 35 and pass into the air inlet of the volute chamber 30. Thus, movement of the handle assembly 88 into the blower mode position opens an air path between the air vents 35 and the impeller 20 to pull air into the housing 18 for operation of the tool 10 as an air blower. Conversely, movement of the handle assembly 88 into the trimmer mode position restricts the air path between the air vents 35 and the impeller 20 so that air cannot be pulled into the housing 18.

The string trimmer head 22 is positioned below the blower housing 18, and as is known in the art, comprises a spool (not shown) of cutting line 96 used to cut vegetation. The cutting line 96 extends from a plurality of apertures 98 located around the circumference of the string trimmer head 22. The connection of the cutting line 96 within the string trimmer head 22 is commonly known in the art and will not be described herein. In the illustrated embodiment there are two apertures 98 on the string trimmer head 22 to allow the use of two cutting lines 96 to cut the vegetation. However, it should be noted that the trimmer head 22 could operate with one or more cutting lines 96. Alternately, the trimmer head 22 can receive one or more fixed length cutting lines 96 using means well understood in the art.

In one embodiment, the trimmer head 22 is operatively connected to the internal drive shaft 26 through a clutching mechanism 99 configured to selectively clutch the trimmer head 22 when the tool 10 is in the trimmer mode of operation and declutch the trimmer head 22 when in the blower mode of operation. The clutching mechanism 99 contains a clutch drum 100 affixed to an upper portion of the trimmer head 22. Desirably, the clutch drum 100 and trimmer head 22 are rotatably affixed to the housing 18, so that the clutch drum 100 is raised and lowered through movement of the housing 18 by selective movement of the handle assembly 88 as described above. A centrifugal clutch 102 adapted to interact with the clutch drum 100 is affixed to the distal end of the internal drive shaft 26 and selectively engages or disengages the trimmer head 22 from the internal drive shaft 26. In the illustrated embodiment, the centrifugal clutch 102 includes a pair of clutch shoes 103 that expand outward when the internal drive shaft 26 is rotated to engage the clutch drum 100 to thereby transmit rotation of the internal drive shaft 26 to the cutting head 22.

Because the clutch drum 100 is affixed to the housing 18, the clutch drum 100 moves up and down relative to the internal drive shaft 26 and the centrifugal clutch 102 when the handle assembly 88 is operated to select the desired mode of operation as discussed above. When the tool 10 is operating in the blower mode of operation, the clutch drum 100 is located in a lowered position relative to the centrifugal clutch 102 such that the centrifugal clutch 102 resides above a circumferential wall 105 of the clutch drum 100. Thus, the centrifugal clutch 102 does not engage the clutch drum 100 in the blower mode and the trimmer head 22 is not rotated by the internal drive shaft 26. When the handle assembly 88 is repositioned to the trimmer mode position, the housing 18, and thus the clutch drum 100, moves upward relative the internal drive shaft 26 and the centrifugal clutch 102. In this orientation, the clutch drum 100 is raised so that the centrifugal clutch 102 nests within the clutch drum 100, and when the internal drive shaft 26 is rotated, the clutch shoes 103 expand outward and engage the clutch drum 100. Thus, the centrifugal clutch 102 only engages the clutch drum 100 in the trimmer mode of operation and the trimmer head 22 is only rotated by the internal drive shaft 26 in the trimmer mode.

A clutch retainer 106 positioned adjacent the centrifugal clutch 102 limits the movement of the clutch shoes 103 away from the central axis when the centrifugal clutch 102 is not nested within the clutch drum 100. The clutch retainer 106 prevents the clutch shoes 103 from continuing to expand outward when the clutch drum 100 is in the lowered position and is thus not in position to check such expansion. The clutch retainer 106 may be a plate that limits the travel of the clutch shoes 103, or may be a molded feature in the underside of the impeller 20, or other device chosen using sound engineering judgment.

With the components of one embodiment described above, the operation of the combination blower/trimmer assembly 16 will now be explained. As previously mentioned, the handle assembly 88 is used to position the housing 18 between a first and second positions relative the shaft boom 12 and support collar 80. When the housing 18 is positioned in the first position as illustrated in FIG. 6 the blower function is operable because air is free to enter the vents 35 and flow to the impeller 20. In the illustrated embodiment, when the housing 18 is in the first position, the restrictor plate 82 is positioned so that it does not obstruct the flow of air from the vents 35 to the impeller 20, thereby allowing air to flow into and through the chamber 30 and out the blower nozzle 32. Additionally, when the housing is in the first position, the trimmer head 22 is inoperable because the clutch mechanism 99 does not transmit rotation of the drive shaft 26 to the trimming head 22. Conversely, when the operator wishes to use the tool 10 in the string trimmer mode, the operator moves the handle assembly 88 to position the housing 18 into the second position. When the housing 18 is positioned in the second position as illustrated in FIG. 5, the blower function is inoperable because the flow path for the air to the impeller 20 is substantially blocked. Specifically, in this position the restrictor plate 82 blocks the flow of air between the vents 35 and the impeller 20. The trimmer head 22 is operable in the second position because the clutching mechanism 99 engages the trimmer head 22 with the drive shaft 26. In the illustrated embodiment, the clutch drum 100 is moved up so that the centrifugal clutch 102 engages the clutch chum 100 to enable powered rotation of the trimmer head 22.

FIG. 7 illustrates another embodiment of the tool 10 in which the shaft boom 12 has an extension mechanism comprising an adjustable mount attaching the blower/trimmer assembly 16 to the distal end of the shaft boom 12. In this embodiment, the blower housing 18 contains a hub 120 that secures the blower/trimmer assembly 16 to the shaft boom 12 in one of two selectable positions. The drive shaft and thus the internal engagement shaft 124 is in a fixed position relative the shaft boom 12. In a trimmer disengaged position, the hub 120 mounts the blower housing 18 on the distal end of the shaft boom 12 in a first position. In this position, the internal engagement shaft 124 engages the impeller 20 but does not engage the string trimmer head 22. In a trimmer engaged position, the hub 120 mounts the blower housing 18 in a position such that a portion of the distal end of the shaft boom 12 is received within a pocket in the blower housing 18. Moving the blower housing 18 from the trimmer disengaged position to the trimmer engaged position therefore causes the internal engagement shaft 124 to move relative to the blower/trimmer assembly 16 such that the internal engagement shaft 124 engages the string trimmer head 22. In one desired embodiment, the internal engagement shaft 124 only engages the impeller 20 in the trimmer disengaged position and only engages the string trimmer head 22 in the trimmer engaged position. However, the internal engagement shaft 124 can engage both the impeller 20 and the string trimmer head 22 in the trimmer engaged position without departing from the scope on the invention. In this later configuration, similar to the embodiment explained above, an air inlet cover 126 forms an air blocking mechanism. The inlet cover 126 is positioned to cover the vents 35 to block air from entering the chamber 30, thereby preventing air from moved through the blower housing 18 so that high pressure air does not leave the nozzle 32 of the housing 18. In one desirable configuration, the act of moving the hub 120 from the disengaged position to the trimmer engaged position simultaneously positions the air inlet cover 126 to block the vents 35.

With the components of this embodiment herein described, the operation of the combination blower/trimmer assembly 16 will now be described. As previously mentioned the hub 120 is rotatable between a first and a second position. When the hub 120 is rotated to the first position, the blower function is operable and the trimmer head 22 is inoperable. Conversely, when the hub 120 is in the second position the blower function is inoperable and tie trimmer head 22 is operable. Furthermore, when the air inlet cover 126 is in the first position the vents 35 are aligned with the air inlet cover 126 such that air is permitted to flow into and through the housing 18 and out the blower outlet 32. Therefore, in order to use the blower function, the operator, prior to starting the power source (not shown), rotates the hub 120 to the first position. The operator then starts the power source and uses a typical control device (not shown) on the shaft boom 12 to operate the blower 10. The operation of the power source and control device is commonly known in the art and will not be described herein. When the operator wishes to use the trimmer head 22, the operator turns off the power source and rotates the hub 120 to the second position so that the drive shaft 124 engages the trimmer head 22.

In an alternate embodiment, as illustrated in FIG. 8, the power tool 10 has a boom extension mechanism, indicated generally at 130, configured to move the internal engagement shaft 124 relative to the string trimmer head 22 and the impeller 20 to selectively operate the desired function of the tool 10. In one embodiment the boom extension mechanism 130 comprises a boom extender 136 in the tubular shaft boom 12 located between the power source and the blower/trimmer assembly 16. As the drive shaft located within the shaft boom 12 has a fixed length, changing the length of the shaft boom 12 with the boom extension mechanism 130 has the effect of changing how far the drive shaft 138 extends past the distal end 65 of the shaft boom 12.

When the length of the shaft boom 12 is selected to the longer length, the internal engagement shaft 124 at the end of the drive shaft 138 engages the impeller 20, but is not long enough to reach the string trimmer head 22. Thus, in this configuration, the power source causes the impeller 20 to rotate allowing the blower to operate, but the string trimmer head 22 does not rotate. When the length of the shaft boom 12 is selected to the shorter length, the internal engagement shaft 124 extends further past the distal end 65 of the shaft boom 12. In this configuration, the internal engagement shaft 124 engages the string trimmer head 22 so that operation of the power source causes the string trimmer head 22 to rotate. In one embodiment, the internal engagement shaft 124 is configured to engage either the impeller 20 or the string trimmer head 22, but not both. Thus, in the second configuration, when the internal engagement shaft 124 engages the string trimmer head 22, the impeller 20 is not engaged by the internal engagement shaft 124 and does not rotate during trimmer operations. In another embodiment, the internal engagement shaft 124 is configured to engage both the string trimmer head 22 and the impeller 20 in the second configuration. However, in this embodiment, the air inlet cover 126 is positioned to cover the vents 35 to block air from entering the air inlet, thereby preventing air from moved through the blower housing 18 so that high pressure air does not leave the nozzle 32 of the blower.

The boom extender 136 is used to selectively lengthen or shorten the length of the tubular shaft boom 12. As illustrated, the tubular shaft boom 12 comprises a lower shaft boom member 12a and an upper shaft boom member 12b telescopingly received into the lower shaft boom member 12a. The lower shaft boom member 12a has a pair of holes (not shown) and the upper shaft boom member 12b has a spring biased push button 140 configured to be received by one of the holes to lock the upper shaft boom member 12b within the lower shaft boom member 12a at one of two selectable lengths. However, other adjustment/locking means to selectively adjust the length of the shaft boom 12 are also envisioned. For example, a threaded member may be used to adjust the length of the shaft boom 12 as illustrated in FIG. 8. Alternately, a thumb screw (not shown) can be inserted through one of the holes and a cooperating hole (not shown) in the upper shaft boom member 12b to adjust the length of the shaft boom 12. Yet other means for adjusting the length of the shaft boom 12 can be used using sound engineering judgment without departing from the scope of the invention.

While this invention has been described in conjunction with the specific embodiments described above, it is evident that many alternatives, combinations, modifications and variations are apparent to those skilled in the art. Accordingly, the preferred embodiments of this invention, as set forth above are intended to be illustrative only, and not in a limiting sense. Various changes can be made without departing from the spirit and scope of this invention.

What is claimed is:

1. A portable multi-purpose tool powered by an attached power source for use as an air blower capable of delivering a high-velocity stream of air when the multi-purpose tool is in a blower mode of operation and as a rotating string trimmer capable of trimming vegetation when the multi-purpose tool is in a trimmer mode of operation, the multi-purpose tool comprising:
a shaft boom;
a drive shaft operatively connected to the power source and configured to be rotated by the power source;
an impeller operatively connected to the drive shaft so as to be rotatable by the power source;
a trimmer head positioned below said impeller, said trimmer head operatively connected to the drive shaft so as to be selectively rotatable by said power source;
a blower housing at a distal end of said shaft boom, said blower housing defining an enclosed chamber and comprising a plurality of vents leading to said chamber and a blower nozzle for directing air from said chamber, wherein the impeller is rotatably mounted within said chamber, and the housing defines an air pathway between said vents and the impeller;
wherein the blower housing is mounted such that the housing is movable between a first and a second position relative the distal end of the shaft boom such that when the multi-purpose tool is in the blower mode of operation, the housing is in said first position and the pathway is open so that air flows through the vents and to the impeller, and when the multi-purpose tool is in the trimmer mode of operation, the housing is in said second position and the pathway is substantially blocked by an air blocking mechanism so that air is substantially prevented from flowing between the vents and the impeller; and
an actuator that moves the housing between the first position and the second position relative to the distal end of the shaft boom.

2. The multi-purpose tool according to claim 1 wherein the chamber is a volute shaped chamber having a center coaxial with an axis of rotation of the impeller and a radius which varies around the circumference of the blower housing.

3. The multi-purpose tool according to claim 1 further comprising a support collar positioned at least partially within said blower housing and affixed to a distal end of said shaft boom, said support collar having a restrictor plate forming the air blocking mechanism, wherein when the housing is positioned in the blower mode of operation, the vents in the housing are substantially positioned one side of the restrictor plate and when the housing is positioned in the trimmer mode of operation, the vents in the housing are substantially positioned on the opposite side of the restrictor plate.

4. The multi-purpose tool according to claim 1 wherein the actuator is a handle assembly pivotably mounted on the support collar with guides that position the blower housing between the first and second positions.

5. The multi-purpose tool according to claim 1 wherein the trimmer head is operatively connected to the drive shaft through a clutching mechanism configured to selectively clutch the trimmer head when in the trimmer mode of operation and declutch the trimmer head when in the blower mode of operation.

6. The multi-purpose tool according to claim 5 wherein the clutching mechanism comprises a centrifugal clutch affixed to the drive shaft and a clutch drum affixed to the trimmer head, wherein the clutch drum is movable with the blower housing between first and second positions such that the centrifugal clutch nests within and engages the clutch drum when the housing is positioned in the trimmer mode of operation and the centrifugal clutch is positioned outside the clutch drum when the housing is positioned in the blower mode of operation so that the centrifugal clutch does not engage the clutch drum.

7. The multi-purpose tool according to claim 6 wherein the clutching mechanism comprises clutch shoes that engage the clutch drum and a clutch retainer that limits the movement of the clutch shoes when the centrifugal clutch is not nested within the clutch drum in the blower mode of operation.

8. A portable multi-purpose tool powered by an attached power source for use as an air blower capable of delivering a high-velocity stream of air when the multi-purpose tool is in a blower mode of operation and as a rotating string trimmer capable of trimming vegetation when in a trimmer mode of operation, the multi-purpose tool comprising:
a tubular shaft boom;
an internal drive shaft operatively connected to the power source and configured to be rotated by said power source;
an impeller operatively connected to the internal drive shaft so as to be rotatable within said chamber;
a trimmer head positioned below said impeller, said trimmer head operatively connected to the internal drive shaft so as to be selectively rotatable by said power source;
a blower housing at a distal end of said shaft boom comprising an enclosed chamber, a plurality of vents leading to said chamber, and a blower nozzle for directing air from said chamber, wherein the impeller is rotatably mounted in said chamber such that the housing defines an air pathway between the vents and the impeller, wherein the blower housing is mounted such that the housing is movable between a first and a second position relative the distal end of the shaft boom; and
an actuator that moves the housing relative the distal end of the shaft boom between a first position for the blower mode of operation and a second position for the trimmer mode of operation; and
a clutching mechanism configured to selectively clutch the trimmer head when in the trimmer mode of operation and declutch the trimmer head when in the blower mode of operation wherein the clutching mechanism comprises a centrifugal clutch affixed to the internal drive shaft and a clutch drum affixed to the trimmer head, wherein the clutch drum is movable with the blower housing between first and second positions such that the centrifugal clutch nests within and engages the clutch drum when the housing is positioned in the trimmer mode of operation and the centrifugal clutch is positioned outside the clutch drum when the housing is positioned in the blower mode of operation so that the centrifugal clutch does not engage the clutch drum.

9. The multi-purpose tool according to claim 8 wherein when the multi-purpose tool is in the blower mode of operation, the housing is in said first position and the pathway is open so that air flows through the vents and to the impeller, and when the multi-purpose tool is in the trimmer mode of operation, the housing is in said second position and the pathway is substantially blocked so that air is substantially prevented from flowing between the vents and the impeller.

10. The multi-purpose tool according to claim 8 further comprising a support collar positioned at least partially within said blower housing and affixed to a distal end of said shaft boom, said support collar having are strictor plate, wherein when the housing is positioned in the blower mode of operation, the vents in the housing are substantially positioned one side of the restrictor plate and when the housing is positioned in the trimmer mode of operation, the vents in the housing are substantially positioned on the opposite side of the restrictor plate.

11. The multi-purpose tool according to claim 8 wherein the actuator is a handle assembly pivotably mounted on the support collar with guides that position the blower housing between the first and second positions.

12. The multi-purpose tool according to claim 8 wherein the clutching mechanism comprises clutch shoes that engage the clutch drum and a clutch retainer that limits the movement of the clutch shoes when the centrifugal clutch is not nested within the clutch drum in the blower mode of operation.

13. A portable multi-purpose tool powered by an attached power source for use as an air blower capable of delivering a high-velocity stream of air when the multi-purpose tool is in a blower mode of operation and as a rotating string trimmer capable of trimming vegetation when in a trimmer mode of operation, the multi-purpose tool comprising:
a tubular shaft boom;
an internal drive shaft operatively connected to the power source and configured to be rotated by said power source;
an impeller operatively connected to the internal drive shaft so as to be rotatable within said chamber;
a trimmer head positioned below said impeller, said trimmer head operatively connected to the internal drive shaft so as to be selectively rotatable by said power source;
a blower housing at a distal end of said shaft boom comprising an enclosed chamber, a plurality of vents leading to said chamber, and a blower nozzle for directing air from said chamber, wherein the impeller is rotatably mounted in said chamber such that the housing defines an air pathway between the vents and the impeller;
means for blocking the flow of air between vents and the impeller when the multi-purpose tool is in the trimmer mode of operation; and
means for disengaging the trimmer head from the internal drive shaft when the multi-purpose tool is in the blower mode.
